(19) United States
(12) Patent Application Publication
(10) Pub. No.: US 2022/0302425 A1
(43) Pub. Date: Sep. 22, 2022

(54) METHOD AND APPARATUS OF MANUFACTURING ANODE FOR ALL-SOLID-STATE BATTERY USING ELECTRIC FIELD

(71) Applicants: Hyundai Motor Company, Seoul (KR); Kia Corporation, Seoul (KR)

(72) Inventors: Yeong Jun Cheon, Daegu (KR); Hoon Seok, Suwon (KR)

(21) Appl. No.: 17/522,657

(22) Filed: Nov. 9, 2021

(30) Foreign Application Priority Data
Mar. 18, 2021 (KR) 10-2021-0035037

(51) Int. Cl. H01M 4/04

(52) U.S. Cl. CPC H01M 4/0404; H01M 4/0409; H01M 2004/027

(57) ABSTRACT

Disclosed are a method and an apparatus of manufacturing an anode for an all-solid-state battery by using an electric field. The manufacturing method includes: preparing a first coating member and a second coating member spaced apart from the first coating member by a predetermined distance; preparing a coating slurry, the coating slurry including a carbon material and a metal alloyable with lithium; feeding the coating slurry to the first coating member; feeding a current collector between the first coating member and the second coating member; and coating the coating slurry on the current collector by using an electric field generated between the first coating member and the second coating member by applying voltages to the first coating member and the second coating member.

### CROSS REFERENCE TO RELATED APPLICATION

The present application claims priority to Korean Patent Application No. 10-2021-0035037, filed Mar. 18, 2021, the entire contents of which is incorporated herein for all purposes by this reference.

### TECHNICAL FIELD

The present invention relates to a method and an apparatus of manufacturing an anode for an all-solid-state battery by using an electric field.

### BACKGROUND

A solid-state battery is formed to include a three-layered laminate in which a cathode active material layer that is bonded to a cathode current collector, an anode active material layer that is bonded to an anode current collector, and a solid electrolyte that is interposed between the cathode active material layer and the anode active material layer are laminated.

Generally, an anode active material layer of an all-solid-state battery is formed by mixing an active material and a solid electrolyte that is to secure ion conductivity. Since a solid electrolyte has a higher specific gravity compared to a liquid electrolyte, a conventional all-solid-state battery as described above has a lower energy density than a lithium-ion battery.

In order to increase an energy density of an all-solid-state battery, research on the use of lithium metal as an anode has been conducted. However, there are problems such as interface bonding, dendrite growth, high cost, and difficulty in increasing size.

Recently, research on an anodeless-type battery wherein an anode of an all-solid-state battery is removed and lithium is directly precipitated to an anode current collector has been conducted.

The anodeless-type all-solid-state battery does not have an anode active material, and has a structure wherein a coating layer having a carbon material, a metal, and so on only exists on an anode current collector. When the anodeless-type all-solid-state battery is charged, lithium is precipitated and stored between the anode current collector and the coating layer.

In the related art, a coating layer has been formed by applying a slurry having a carbon material, a metal, and so on to an anode current collector by known techniques such as a gravure coating. However, due to a movement of metals caused by a volatilization of an organic solvent after applying the slurry, a distribution of metals in the coating layer became non-uniform. In addition, a coating layer having a high density may not be obtained due to the flocculation of materials when materials are in a slurry state. Moreover, cracks in a coating layer were generated when a pressurizing process was performed on the coating layer, so that an internal short-circuit occurred during cell manufacturing and/or charging and discharging.

### SUMMARY

In preferred aspects, provided is a method of manufacturing an anode for an all-solid-state battery. The method may uniformly manufacture a coating layer on an anode current collector, and provide an apparatus for manufacturing the anode.

In one preferred aspect, provided is a method of manufacturing an anode for an all-solid-state battery in which a movement of metal due to a volatilization of a solvent is suppressed, and to provide an apparatus for manufacturing the anode.

In one preferred aspect, provided is a method of manufacturing an anode for an all-solid-state battery with a simplified process, and to provide an apparatus for manufacturing the anode.

The objectives of the present invention are not limited to the foregoing. The objectives of the present invention will be clearly understood through the following description and realized by the means described in the claims and combinations thereof.

In an aspect, provided is a method of manufacturing an anode for an all-solid-state battery. The method may include: preparing a first coating member and a second coating member spaced apart from the first coating member by a predetermined distance; preparing a coating slurry, the coating slurry including a carbon material and a metal alloyable with lithium; feeding the coating slurry to the first coating member; feeding a current collector to a gap between the first coating member and the second coating member; and coating the coating slurry on the current collector by using an electric field generated between the first coating member and the second coating member by applying voltages to the first coating member and the second coating member.

The term “alloyable” as used herein refers to a property of material which is able to form an alloy with a metal component. In certain aspect of the present invention, an alloyable material, e.g., metal, may form an alloy with another metal (e.g., lithium) without occurrence of segregation, precipitation, aggregation, or phase separation.

The second coating member may be positioned above the first coating member.

A distance between the first coating member and the second coating member may be about 6 cm to 17 cm.

The first coating member may be a rotatably installed coating roll, and wherein the coating roll may be positioned above a container in which the coating slurry is accommodated, and the coating roll may be configured such that the coating slurry is attached to a surface of the coating roll by rotating the coating roll.

The current collector may be continuously fed between the first coating member and the second coating member at a speed of about 0.5 m/min to 0.8 m/min.

The current collector may be fed in a roll-to-roll manner.

The voltages may be applied to the first coating member and the second coating member such that a voltage difference between the first coating member and the second coating member may range from about 14 kV to about 24 kV.

A ground voltage may be applied to the second coating member.

The coating slurry may be coated to the current collector by moving in a direction opposite to gravity from the first coating member.

A loading amount of the coating slurry that is coated to the current collector may be about 0.8 mg/cm² to 1.0 mg/cm².

In an aspect, provided is an apparatus for manufacturing an anode for an all-solid-state battery. The apparatus may include: a container in which a coating slurry including a carbon material and a metal alloyable with lithium is accommodated; a first coating member installed above the container and having a surface with a predetermined area to which the coating slurry is attached; a second coating member spaced apart from the first coating member by a predetermined distance; a transfer unit configured to feed a current collector to a gap between the first coating member and the second coating member; and a power component connected to the first coating member and the second coating member and configured to generate an electric field between the first coating member and the second coating member by applying voltages to the first coating member and the second coating member, wherein the coating slurry attached to the surface of the first coating member is coated to the current collector through the electric field.

The second coating member may be positioned above the first coating member, and a distance between the first coating member and the second coating member may be about 6 cm to 17 cm.

At least one of the first coating member and the second coating member may be installed to be movable in an up and down direction.

The first coating member may be a rotatably installed coating roll, and the coating slurry is attached to the surface of the first coating member by the coating roll that is rotated above the container.

The coating roll may include at least one groove on a surface thereof, the groove having a predetermined width.

The transfer unit may include transferring rolls that are installed respectively at an inlet side and an outlet side of the first and second coating members.

The transfer unit may be configured to feed the current collector to the gap between the first coating member and the second coating member at a speed of about 0.5 m/min to 0.8 m/min.

The power component may be configured to apply the voltages to the first coating member and the second coating member such that a voltage difference between the first coating member and the second coating member may range from about 14 kV to 24 kV.

The power component may be configured to apply a ground voltage to the second coating member.

The coating slurry may be coated to the current collector by moving in a direction opposite to gravity from the first coating member.

According to various exemplary embodiments of the present invention, by applying a coating slurry to a current collector through an electric field, a coating layer may be uniformly formed on an anode current collector without the flocculation of materials.

According to various exemplary embodiments of the present invention, a movement of metals due to a volatilization of a solvent may be suppressed, so a coating layer in which metals are uniformly distributed may be efficiently formed.

According to various exemplary embodiments of the present invention, an amount of a binder may be reduced, and a coating layer may be manufactured without performing an additional process such as a pressing after coating.

The effects of the present invention are not limited to the foregoing. The effects of the present invention should be understood to include all effects that can be reasonably anticipated from the following description.

Other aspects of the invention are disclosed infra.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 shows an exemplary all-solid-state battery according to an exemplary embodiment of the present invention;

FIG. 2 shows an exemplary state in which the all-solid-state battery according to an exemplary embodiment of the present invention is charged;

FIG. 3 shows an exemplary apparatus of manufacturing an anode for an all-solid-state battery according to an exemplary embodiment of the present invention;

FIG. 4 shows a modified version of a first coating member according to an exemplary embodiment of the present invention;

FIG. 5A shows a result of analyzing an anode in Example 1 according to an exemplary embodiment of the present invention by using a scanning electron microscope (SEM);

FIG. 5B shows a result of analyzing an anode in Comparative Example 1 by using a SEM;

FIG. 6A shows a result of evaluating a cell performance of an all-solid-state battery having an anode in the Example 1 according to an exemplary embodiment of the present invention; and

FIG. 6B shows a result of evaluating a cell performance of an all-solid-state battery having an anode in the Comparative Example 1.

### DETAILED DESCRIPTION

The objectives, features, and advantages of the present invention will be easily understood through the following detailed description of specific exemplary embodiments and the attached drawings. However, the present invention is not limited to the exemplary embodiments and may be embodied in other forms. On the contrary, the exemplary embodiments are provided so that the invention of the present invention may be completely and fully understood by those of ordinary skill.

In the attached drawings, like numerals are used to represent like elements. In the drawings, the dimensions of the elements are enlarged for easier understanding of the present invention. Although the terms first, second, etc. may be used to describe various elements, these elements should not be limited by the terms. The terms are used only to distinguish one element from another. For example, a first element can be termed a second element and, similarly, a second element can be termed a first element without departing from the scope of the present invention. A singular expression includes a plural expression unless the context clearly indicates otherwise.

In the present invention, terms such as “include”, “contain”, “have”, etc. should be understood as designating that features, numbers, steps, operations, elements, parts or combinations thereof exist and not as precluding the existence of or the possibility of adding one or more other features, numbers, steps, operations, elements, parts, or combinations thereof in advance. In addition, when an element such as a layer, a film, a region, a substrate, etc. is referred to as being “on” another element, it can be “directly on” the another element or an intervening element may also be present. Likewise, when an element such as a layer, a film, a region, a substrate, etc. is referred to as being “under” another element, it can be “directly under” the another element or an intervening element may also be present.

Unless specified otherwise, all the numbers, values and/or expressions representing the amount of components, reaction conditions, polymer compositions or mixtures are approximations reflecting various uncertainties of measurement occurring in obtaining those values and should be understood to be modified by “about”. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Also, unless specified otherwise, all the numerical ranges disclosed in the present invention are continuous and include all the values from the minimum values to the maximum values included in the ranges. In addition, when the ranges indicate integers, all the integers from the minimum values to the maximum values included in the ranges are included unless specified otherwise. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

FIG. 1 shows an exemplary all-solid-state battery according to the present invention. As shown in FIG. 1, the all-solid-state battery may include: a cathode 100 including a cathode current collector 110 and a cathode active material layer 120; an anode 200 including an anode current collector 210 and a coating layer 220; and a solid electrolyte layer 300 positioned between the cathode 100 and the anode 200. At this time, the anode 200 and the solid electrolyte layer 300 are laminated such that the solid electrolyte layer 300 and the coating layer 220 are in contact with each other.

The cathode current collector 110 may be a plate-shaped substrate that is electrically conductive. The cathode current collector 110 may include an aluminum foil.

The cathode active material layer 120 may include a cathode active material, a solid electrolyte, a conductive material, a binder, and so on.

In addition, the cathode active material may be an oxide active material or a sulfide active material.

For example, the oxide active material may include a rock-salt-layer-type active material such as LiCoO₂, LiMnO₂, LiNiO₂, LiVO₂, Li₁₊ₓNi_{1/3}Co_{1/3}Mn_{1/3}O₂ and the like, a spinel-type active material such as LiMn₂O₄, Li(Ni_{0.5}Mn_{1.5})O₄ and the like, an inverse-spinel-type active material such as LiNiVO₄, LiCoVO₄ and the like, an olivine-type active material such as LiFePO₄, LiMnPO₄, LiCoPO₄, LiNiPO₄ and the like, a silicon-containing active material such as Li₂FeSiO₄, Li₂MnSiO₄ and the like, a rock-solid-layer-type active material in which a portion of a transition metal is substituted with a different metal, such as LiNi_{0.8}Co_{(0.2-x)}AlₓO₂(0<x<0.2); a spinel-type active material in which a portion of a transition metal is substituted with a different metal, such as Li₁₊ₓMn_{2-x-y}M_{y}O₄(M being at least one of Al, Mg, Co, Fe, Ni and Zn, 0<x+y<2); or lithium titanate such as Li₄Ti₅O₁₂ and the like.

The sulfide active material may include copper Chevrel, iron sulfide, cobalt sulfide, nickel sulfide, etc.

The solid electrolyte may include an oxide-based solid electrolyte or a sulfide-based solid electrolyte. However, the sulfide-based solid electrolyte may preferably have high lithium-ion conductivity. The sulfide-based solid electrolyte is not particularly limited, and may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one of Ge, Zn, and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga, and In), Li₁₀GeP₂S₁₂, etc.

The conductive material may include carbon black, conducting graphite, ethylene black, graphene, etc.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), or the like.

The anode 200 includes the anode current collector 210 and the coating layer 220 that is positioned on the anode current collector 210.

The anode current collector 210 may include a plate-shaped substrate being electrically conductive. The anode current collector 210 may include a foam that is electrically conductive and flexible. The anode current collector 210 may be a metal foam including at least one selected from the group consisting of nickel (Ni), stainless steel (SUS), and a combination thereof.

A thickness of the anode current collector 210 may be about 1 μm to 20 μm, or about 5 μm to 15 μm.

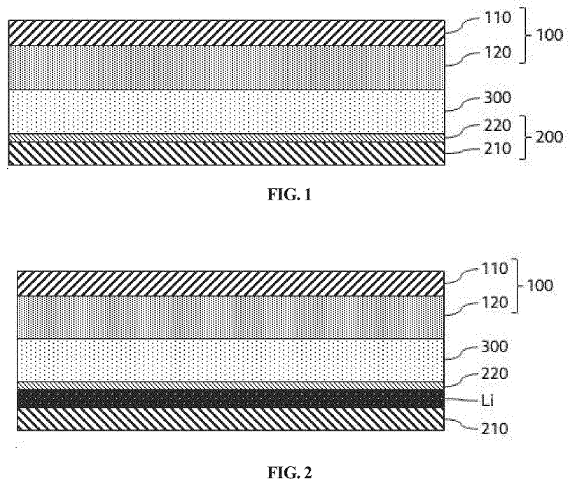

FIG. 2 is a cross-sectional view illustrating a state in which the all-solid-state battery according to the present invention is charged. As shown in FIGS. 1 and 2, lithium ions that have moved from the cathode 100 when the battery was charged are precipitated and stored between the coating layer 220 and the anode current collector 210 in a form of lithium metal (Li).

The coating layer 220 may include a carbon material and a metal alloyable with lithium.

The carbon material may include amorphous carbon. The carbon material may preferably include amorphous carbon including at least one selected from the group consisting of furnace black, acetylene black, ketjen black, graphene, and a combination thereof.

The metal alloyable with lithium may include one or more selected from the group consisting of gold (Au), platinum (Pt), palladium (Pd), silicon (Si), silver (Ag), aluminum (Al), bismuth (Bi), tin (Sn), and zinc (Zn).

The coating layer 220 may further include a binder. The binder is not particularly limited, and may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), or the like.

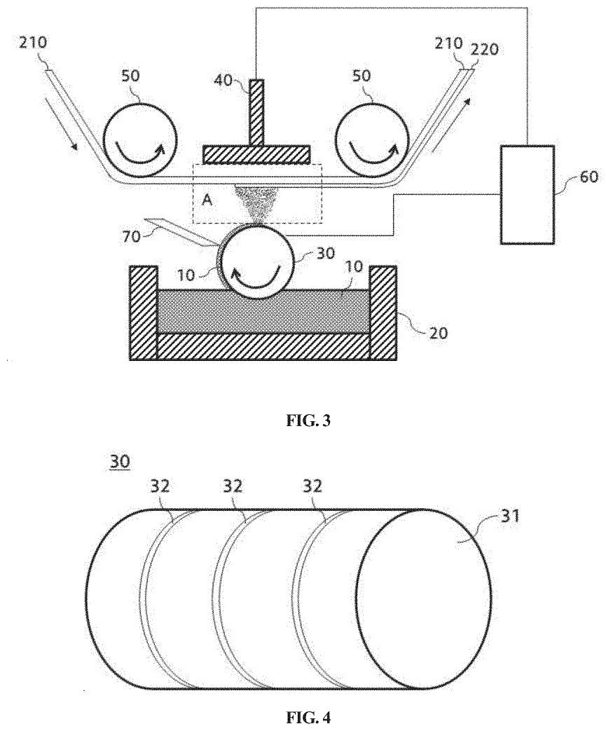

FIG. 3 shows an exemplary apparatus of manufacturing an anode for an all-solid-state battery according to an exemplary embodiment of the present invention. As shown in FIG. 3, the manufacturing apparatus may include: a container 20 in which a coating slurry 10 including a carbon material and a metal alloyable with lithium is accommodated; a first coating member 30 installed above the container 20 and having a surface with a predetermined area to which the coating slurry 10 is attached; a second coating member 40 spaced apart from the first coating member 30 by a predetermined distance; a transfer unit 50 configured to feed a current collector 210 to a gap between the first coating member 30 and the second coating member 40; and a power component 60 connected to the first coating member 30 and the second coating member 40, and configured to generate an electric field between the first coating member 30 and the second coating member 40 by applying voltages to the first coating member 30 and the second coating member 40.

The coating slurry 10 may include a material to form the coating layer 220, and the coating slurry 10 may be obtained by adding aforementioned carbon material and aforementioned metal alloyable with lithium into a solvent. The coating slurry 10 may further include a binder.

The container 20 may be formed of an insulating material. Since the voltage is applied to the coating member 30 through the power component 60, it may be preferable to use the container 20 that is formed of an insulating material due to safety reasons.

The first coating member 30 may be installed above the container 20. In particular, as shown in FIG. 3, the first coating member 30 may be installed at a position where a part of the first coating member 30 is immersed in the coating slurry 10 that is stored in the container 20.

The first coating member 30 may include a rotatably installed coating roll, and the coating slurry 10 may be attached to the surface of the first coating member 30 by the coating roll that is rotated above the container 20. At this time, a blade 70 may be installed in accordance with a rotating direction of the first coating member 30, so that the coating slurry 10 may be attached to the surface of the coating roll with a uniform thickness.

The first coating member 30 may be a cylindrical coating roll having a smooth surface, or may include at least one groove 32 formed on a cylindrical body portion 31 and a surface of the body portion 31 by being recessed with a predetermined width and depth. Since the coating slurry 10 is not attached to the groove 32, by appropriately adjusting a shape and a position of the groove 32, the coating layer 220 may have a pattern according to the shape and the position of the groove 32.

The second coating member 40 may be installed above the first coating member 30. Particularly, the second coating member 40 may be positioned on a position in a direction opposite with respect to the direction in which gravity acts on the first coating member 30. When an electric field is generated between the first coating member 30 and the second coating member 40 by the power component 60, the coating slurry 10 that is attached to the surface of the first coating member 30 may be applied to the current collector 210 by moving in the opposite direction of gravity. This will be described later.

The second coating member 40 may include a grounding member. The power component 60 may apply a ground voltage to the second coating member 40. In order to generate an electric field capable of moving the coating slurry 10 sufficiently, a voltage difference equal to or greater than a predetermined level may be needed. However, when the ground voltage is applied to the second coating member 40 by the power component 60, the voltage difference may be managed and adjusted easily because the voltage of a desired level can be directly applied to the first coating member 30 without addition or subtraction of the voltage. However, the second coating member 40 is not limited to the grounding member, and may include any component that can generate a voltage difference equal to or more than a predetermined level between the first coating member 30 and the second coating member 40.

A shape of the second coating member 40 is not particularly limited, and may have various shapes such as plate type, conveyor type, etc.

The transfer unit 50 is configured to feed the current collector 210 to a gap between the first coating member 30 and the second coating member 40. Particularly, the transfer unit 50 may include transferring rolls that are installed respectively at an inlet side and an outlet side of the first and second coating members 30 and 40. The inlet side and the outlet side are defined based on a moving direction of the current collector 210. A side where the current collector 40 enters into a gap between the first coating member 30 and the second coating member 40 is defined as the inlet side, and a side where the current collector 40 exits is defined as the outlet side.

In a method of manufacturing an anode for an all-solid-state battery according to an exemplary embodiment of the present invention, the coating layer 220 may be formed on the current collector 210 during a movement of the current collector 210 by using a roll-to-roll manner, so that an anode may be obtained through a continuous and simplified process.

The power component 60 is configured to generate an electric field on a space between the first coating member 30 and the second coating member 40 by applying voltages. Particularly, the power component 60 may apply a predetermined voltage to the first coating member 30, and may apply the ground voltage to the second coating member 40. In an electric field generation area (A), the coating slurry 10 attached to the surface of the first coating member 30 may be applied to the current collector 210 passing through the electric field generation area (A) by moving along the direction of the electric field that is a direction opposite to gravity.

According to an exemplary embodiment of the present invention, the coating slurry 10 may be coated by the electric field, so that metals included in the coating slurry 10 may not be flocculated, and thus the coating slurry 10 may be uniformly and densely coated. In addition, since the coating slurry 10 is coated by moving in the direction opposite to gravity, particles such as beads that have been increased in the size by being flocculated may be easily excluded. A coating condition of the coating slurry 10 by using the electric field will be more specifically described hereinafter.

The method of manufacturing an anode for an all-solid-state battery may include: preparing the first coating member 30 and the second coating member 40 spaced apart from the first coating member 30 by a predetermined distance; preparing the coating slurry 10, the coating slurry 10 including a carbon material and a metal alloyable with lithium; feeding the coating slurry 10 to the first coating member 30; feeding the current collector 210 to a gap between the first coating member 30 and the second coating member 40; and coating the coating slurry 10 to the current collector 210 by using the electric field A generated between the first coating member 30 and the second coating member 40 by applying the voltages to the first coating member 30 and the second coating member 40.

Hereinafter, each process of the manufacturing method according to the present invention will be more easily understood by referring to the description of the above-described manufacturing apparatus of an anode for an all-solid-state battery.

A distance between the first coating member 30 and the second coating member 40 may in a range of about 6 cm to 17 cm, or in a range of about 7.5 cm to 15 cm. When the distance between the first coating member 30 and the second coating member 40 is less than about 6 cm, a distance between the coating slurry 10 and the current collector 210 becomes excessively close so that a flocculation of particles in the coating slurries 10 may occur. When the distance between the first coating member 30 and the second coating member 40 is greater than about 17 cm, the coating layer 200 may not be uniformly formed due to an increased travel distance of the coating slurry 10, or beads with large particle sizes may be formed due to increased contact between the coating slurries 10 during the travel.

The current collector 210 may be fed to the gap between the first coating member 30 and the second coating member 40 by the transfer unit 50 aforementioned. Particularly, the current collector 210 may be continuously fed at a speed of about 0.5 m/min to 0.8 m/min. However, the fed speed of the current collector 210 may be appropriately adjusted depending on a desired loading amount of the coating layer 220.

A voltage difference between the first coating member 30 and the second coating member 40 may be in a range of about 14 kV to 24 kV, in a range of about 13 kV to 22 kV, or particularly in a range of about 16 kV to 22 kV. When the second coating member 40 includes a grounding member so that a ground voltage is applied to the second coating member 40, the above-described power component 60 may apply a voltage in a range of about 14 kV to 24 kV, in a range of about 13 kV to 22 kV, or in a range of about 16 kV to 22 kV to the first coating member 30. When the voltage difference between the first coating member 30 and the second coating member 40 is less than about 14 kV, a flocculation of particles in the coating slurry 10 may occur. When the voltage difference is greater than about 24 kV, beads with large particle sizes may be formed.

The manufacturing method may be coating the coating slurry 10 to the current collector 210 with a loading amount of about 0.8 mg/cm² to 1.0 mg/cm². However, the loading amount of the coating slurry 10 may be appropriately adjusted depending on a desired performance of a cell.

### EXAMPLE

Hereinafter, the present invention will be described more specifically through examples. However, these examples are provided only for the understanding of the present invention, and the scope of the present invention is not limited to these examples.

### Example 1

A coating layer was formed on a current collector by preparing a manufacturing apparatus for the anode as illustrated in FIG. 3. An anode current collector was fed to an electric field generation area (A) that was generated between a first coating member and a second coating member. A ground voltage was applied to the second coating member, and a predetermined level of voltage was applied to the first coating member, so that the electric field was generated therebetween. A coating slurry including a carbon material and a metal alloyable with lithium was deposited on the anode current collector through the electric field. A thickness of the coating layer was 5.5 μm, and a post-process such as a pressurization was not performed.

### Comparative Example 1

The same coating slurry as the Example 1 was applied to an anode current collector at a thickness of about 11.8 μm, and a coating layer having a thickness of about 5.6 μm was formed by pressurizing a predetermined pressure after drying.

### Experimental Example 1

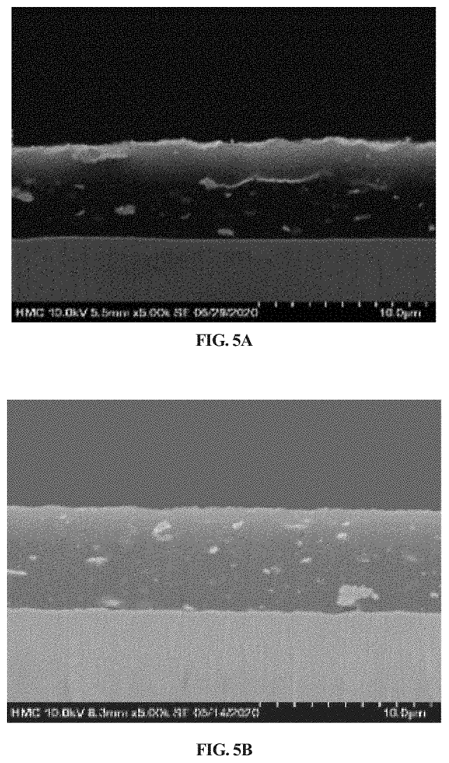

Scanning electron microscope analysis was performed on anodes according to the Example 1 and the Comparative Example 1. FIG. 5A shows a result of analyzing the anode according to the Example 1, and FIG. 5B shows a result of analyzing the anode according to the Comparative Example 1. As shown in FIG. 5A, a uniform and dense coating layer may be formed by using the manufacturing method using the electric field according to the present invention.

### Experimental Example 2

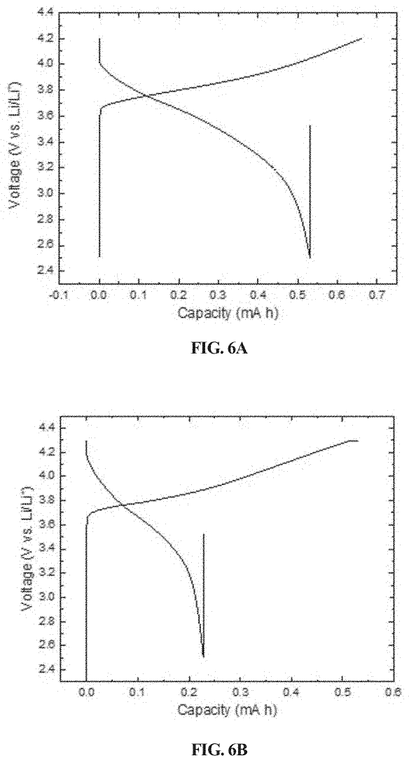

After manufacturing all-solid state batteries through the same process as illustrated in FIG. 1 by using the anodes according to the Example 1 and the Comparative Example 1, cell performances according to the each all-solid-state batteries were evaluated. FIG. 6A shows a result of evaluating a cell performance of an all-solid-state battery having an anode according to the Example 1, and FIG. 6B is a graph showing a result of evaluating a cell performance of an all-solid-state battery having an anode according to the Comparative Example 2. As shown in FIG. 6B, a discharge performance of the Comparative Example 1 was reduced. Accordingly, an internal short-circuit was occurred in the Comparative Example 1. On the contrary, referring to FIG. 6A, the all-solid-state battery according to the present invention has an excellent result.

### Example 3 to Example 6, Comparative Example 2, and Comparative Example 3

In the same manufacturing apparatus as illustrated in FIG. 3, a distance between a first coating member and a second coating member was adjusted as shown in Table 1, and a coating layer was formed by the same method as the Example 1. A state of the manufactured coating layer was checked by a scanning electron microscope, a visual inspection, and so on.

TABLE 1

| | Distance between first | | |
|---|---|---|---|
| | coating member and second | | |
| Division | coating member | | State |
| Comparative | 5 | cm | Occurrence of Drop |
| Example 2 | | | and Beads |
| Example 3 | 7.5 | cm | Normal |
| Example 4 | 10 | cm | Normal |
| Example 5 | 12.5 | cm | Normal |
| Example 6 | 15 | cm | Normal |
| Comparative | 17.5 | cm | Beads occurred |
| Example 3 | | | |

As shown in Table 1, when a distance between a first coating member and a second coating member was less than 6 cm or less than 7.5 cm, a state of a coating layer was not good due to the occurrence of drop and beads, and when a distance between a first coating member and a second coating layer was greater than 15 cm or greater than 17 cm, beads were also formed.

### Example 7 to Example 10, Comparative Example 4, and Comparative Example 5

In the same manufacturing apparatus as illustrated in FIG. 3, a ground voltage was applied to a second coating member and a voltage as shown in Table 2 was applied to a first coating member, and a coating layer was formed by the same method as the Example 1. A state of the manufactured coating layer was checked by a scanning electron microscope, a visual inspection, and so on.

TABLE 2

| | Voltage applied to | |
|---|---|---|
| Division | first coating member | State |
| Comparative | 10 kV | Occurrence of Drop |
| Example 4 | | and Flocculation |
| Example 7 | 13 kV | Normal |
| Example 8 | 16 kV | Normal |
| Example 9 | 19 kV | Normal |
| Example 10 | 22 kV | Normal |
| Comparative | 25 kV | Beads occurred |
| Example 5 | | |

As shown in Table 2, when a voltage difference between a first coating member and a second coating member was less than 12 kV or less than 14 kV, a state of a coating layer was not good due to the occurrence of drop and flocculation, and when the voltage difference was greater than 22 kV or greater than 24 kV, beads were formed.

As described above, while the experimental example and the exemplary embodiments of the present invention have been specifically described, the scope of the present invention is not limited to the above-disclosed experimental example and embodiments, and various modifications and improvements of those skilled in the art using the basic concept of the present invention, which is defined in the appended claims, are also included in the scope of the present invention.

What is claimed:

1. A method of manufacturing an anode for an all-solid-state battery, comprising:
preparing a first coating member and a second coating member spaced apart from the first coating member by a predetermined distance;
preparing a coating slurry, the coating slurry comprising a carbon material and a metal alloyable with lithium;
feeding the coating slurry to the first coating member;
feeding a current collector to a gap between the first coating member and the second coating member; and
applying the coating slurry on the current collector by using an electric field generated between the first coating member and the second coating member by applying voltages to the first coating member and the second coating member.

2. The method of claim 1, wherein the second coating member is positioned above the first coating member.

3. The method of claim 1, wherein a distance between the first coating member and the second coating member is about 6 cm to 17 cm.

4. The method of claim 1, wherein the first coating member is a rotatably installed coating roll, and
wherein the coating roll is positioned above a container in which the coating slurry is accommodated, and the coating roll is configured such that the coating slurry is attached to a surface of the coating roll by rotating the coating roll.

5. The method of claim 1, wherein the current collector is continuously fed between the first coating member and the second coating member at a speed of about 0.5 m/min to 0.8 m/min.

6. The method of claim 1, wherein the current collector is fed in a roll-to-roll manner.

7. The method of claim 1, wherein the voltages are applied to the first coating member and the second coating member and a voltage difference between the first coating member and the second coating member ranges from about 14 kV to about 24 kV.

8. The method of claim 1, wherein a ground voltage is applied to the second coating member.

9. The method of claim 1, wherein the coating slurry is applied to the current collector by moving in a direction opposite to gravity from the first coating member.

10. The method of claim 1, wherein a loading amount of the coating slurry that is applied to the current collector is about 0.8 mg/cm² to 1.0 mg/cm².

11. An apparatus for manufacturing an anode for an all-solid-state battery, comprising:
a container in which a coating slurry comprising a carbon material and a metal alloyable with lithium is accommodated;
a first coating member installed above the container and having a surface with a predetermined area to which the coating slurry is attached;
a second coating member spaced apart from the first coating member by a predetermined distance;
a transfer unit configured to feed a current collector to a gap between the first coating member and the second coating member; and
a power component connected to the first coating member and the second coating member and configured to generate an electric field between the first coating member and the second coating member by applying voltages to the first coating member and the second coating member,
wherein the coating slurry attached to the surface of the first coating member is coated to the current collector through the electric field.

12. The method of claim 11, wherein the second coating member is positioned above the first coating member, and a distance between the first coating member and the second coating member is about 6 cm to 17 cm.

13. The method of claim 11, wherein at least one of the first coating member and the second coating member is installed to be movable in an up and down direction.

14. The method of claim 11, wherein the first coating member is a rotatably installed coating roll, and the coating slurry is attached to the surface of the first coating member by the coating roll that is rotated above the container.

15. The method of claim 14, wherein the coating roll comprises at least one groove on a surface thereof, the groove having a predetermined width.

16. The method of claim 11, wherein the transfer unit comprises transferring rolls that are installed respectively at an inlet side and an outlet side of the first and second coating members.

17. The method of claim 11, wherein the transfer unit is configured to feed the current collector to the gap between the first coating member and the second coating member at a speed of about 0.5 m/min to 0.8 m/min.

18. The method of claim 11, wherein the power component is configured to apply the voltages to the first coating member and the second coating member such that a voltage difference between the first coating member and the second coating member is to be about 14 kV to 24 kV.

19. The method of claim 11, wherein the power component is configured to apply a ground voltage to the second coating member.

20. The method of claim 11, wherein the coating slurry is coated to the current collector by moving in a direction opposite to gravity from the first coating member.
